(19) United States
(12) Patent Application Publication
(10) Pub. No.: US 2017/0186075 A1
(43) Pub. Date: Jun. 29, 2017

(54) METHOD AND SOFTWARE FOR CONTROLLING A PROJECT-SPECIFIC VENDOR QUERY FOR INDUSTRIAL OPERATIONS

(71) Applicant: Alexis S. Husser, Richmond, TX (US)

(72) Inventor: Alexis S. Husser, Richmond, TX (US)

(21) Appl. No.: 14/565,425

(22) Filed: Feb. 24, 2015

(51) Int. Cl. G06Q 30/06

(52) U.S. Cl. CPC G06Q 30/0635

(57) ABSTRACT

This control process allows buyers to select vendors based upon their project and geographic proximity. Once potential vendors are identified and selected purchase orders are generated and communicated to the vendors. Based upon the project, vendors are identified and purchase orders generated for most if not all of the required products, tools, and materials that are relevant to the operations and project. Additionally, the control process can be filtered according to customizable buyer priorities and buyer feedback.

This application is based upon and claims priority from U.S. Provisional Application, Ser. No. 61/913,710, which is incorporated herein by reference.

### BACKGROUND OF THE INVENTION

Field of the Invention

Applicants' invention relates to a method and software allowing a contractor to identify vendors of required products, tools, and materials that are geographically relevant to contractor operations and consistently able to deliver the service, quality, and operational safety required. More particularly, it relates to the method and software for a comprehensive, web-based application that provides a geographical directory where resources are identified according to project type and project location and said resources can be filtered according to customizable buyer priorities.

Background Information

As used herein, “contractor” is intended to broadly include anyone who is a buyer of industrial services/products. Such a contractor will generally be organizing or running a construction project. “Construction” is also intended to be broadly interpreted as any work on a project that could include, but is not limited to, oil and gas operations, structure construction, modification, repair, or demolition, and underground or under-water projects. Conventionally, contractors would identify tools and materials needed for a given project, attempt to identify vendors that sell or provide those tools and materials, contact the chosen vendors, then arrange for purchase and shipping of the tools and materials. This can be an inefficient and costly procedure because relevant vendors may not be identified and shipping costs for a distant vendor may far exceed those of a closer one.

### SUMMARY OF THE INVENTION

The present invention includes the method and software that automates the identification of, and communications with, qualified providers of industrial services, materials, tools, and products. The method of the present invention anticipates the system is anticipated to be more useful, when used as an integrated system by users on stand-alone machines having access to a central database located on a remote server that is populated by information received from multiple remote locations; but can accommodate being run by software that can be located on a stand-alone machine with an included database. Access to the remote server can be via the Internet, or other intranet and extranet, web systems.

By automating the vendor search and identification, and providing the user with crucial information, the present invention enables the user to choose vendors that tend to be located closer to the job-site, thus reducing freight and shipping costs, as well as making contact with the vendor easier. Transportation costs are significant, so buyers need to procure high-quality products and services close to the point of use just as they are required. Suppliers need to immediately inform customers of product and service statuses as they evolve to ensure high utilization rates and more quickly generate revenue from new investments. The present invention provides an efficient interaction point where buyer and vendor needs are met simultaneously.

The present invention is an integrated solution that consolidates vendor and product information with geographical location information and considers that information with the user's project needs. By detecting previously unknown relationships, such as relative location, the system is able to select potential vendors based upon applicability and accessibility.

The user defines a project according to industry, project type, location, and execution timeline. With this input, the system generates a service list, creating a prospective vendor list based on proximity. The user can filter and refine that list according to its policies and preferences. The system can communicate with the chosen vendors, including sending a request for quote (“RFQ”) to each of those vendors. Because of the system integration, vendor selection and contact can be accomplished in a very short time. Vendors will receive notification of the RFQ and can respond. Upon evaluation of proposals, and any necessary clarifications, the user is able to then make selections and notify vendors of selections. The vendor list is then exported for use on the job with appropriate sales, technical and dispatch contacts readily available. It can also be shared and managed by other related users that have operational or purchasing responsibility.

Upon the creation or start of a project, the user provides the system an industry identifier, segment, development phase and geographic location, the system provides a list of known products and services that are required to execute that project. Based on the selection criteria indicated by the user, either across the project or at a product/service level individually, the system will provide a list of vendors for each product and service. The length of that list is also customizable and can be filtered according to management specifics like liability insurance levels, safety certifications, implementation of industry standards, or even approved vendor lists.

At any point during planning or implementation, the user can modify the project parameters to add or replace vendors as needed. If the timeline or scope of the project changes, a quick modification of the project can be made and selected vendors are automatically notified.

Once filtered, the vendor list can be contacted through the system en masse and provided with an RFQ around which proposals can be generated. Mobile apps may be used to notify vendor representatives that proposal requests are pending. The proposals are sent back to the system and upon review, the user can make final vendor selections. With necessary documentation in place, purchase orders can be delivered with a notification of award or status as backup vendor. A unique identifier is created for the project-node relationship that is created at this point.

Upon completion of the work associated with each particular project-node entity, the user can provide feedback on the quality of service provided by each vendor. This data is incorporated into the system's vendor database and the feedback is assigned to the specific vendor, location, and service used. As the system develops, this information will be available during the selection process to screen vendors according to quality requirements.

Vendor lists can be ported to subsequent projects in the same area, modified again as needed, and as additional feedback is provided performance metrics can be tracked over time. A given vendor's performance on multiple projects can thus be compared in reference to future projects.

Profiles relating to the vendors are built to provide relevant location, service, product, and selection information. Vendors can use the system by identifying points of service and the specific services available at each location. A vendor will have an array of service nodes that are connected to new projects as they are created. If a new service is added or a location opened, that information is available instantly to potential customers that use the system and who are in need of those services. Nodes can be created in a static format or dynamically, which accommodates mobile services, for example in the oil and gas industry - rigs or frac crews. In addition, vendors can add hyperlinks to any node that provide direct access to vendor sites or content associated with that particular node.

The system contains pre-defined, customizable rules and tolerances that are used to identify and filter potential vendors for specific projects at given locations. And because there is a historical record of every transaction within the system, complete audit trail and trend recognition capability is provided. Based upon users providing feedback on chosen criteria such as safety, quality, timeliness, professionalism and corporate support, the system can capture vendor performance statistics across large operating areas and vendors can quickly correct problems that might be happening far from the operating base. Buyers are also able to capture this data en masse for their projects to compare vendor performance and work with preferred vendors to manage service quality issues effectively.

The present invention utilizes a dynamic, improvable database, or data repository, which is initially populated with data from disparate administration and transaction information from the user. Once the database is populated, real-time and/or batch updating occurs and provides the software of the present invention with the information necessary to improve the information.

It is anticipated that the system database can include any number of types of construction and industrial projects. Vendor product information developed in the database can provide the basis for the development of an interactive catalog. Buyers can then see exactly which vendor has the necessary products on hand when that item is required. The vendor and location, or “node” can become a “super node” that includes availability dates whereby users can connect to nodes that are indeed available at the anticipated utilization date. Users are able to maintain operational focus rather than spending time on the phone searching for parts that are often difficult to find on non-industry search engines.

The present invention provides control functionality that will generate a series of project-node “objects”. These objects are used to facilitate the exchange of goods and services associated with operational exercises including, but not limited to, oil and gas exploration, drilling, completion, and well servicing, decommissioning, infrastructure development as well as transportation and structure construction. Users of the present invention include two classes which are defined as buyers and vendors. Vendors, a class that may include, for example, sales and marketing personnel, service delivery personnel, and operational personnel, input node details into the system. Each node in the system, having unique characteristics defined by the vendor and constrained by the system, is available for universal query by any buyer. Buyers, a class that may include engineers, project managers, administrative personnel, and purchasing agents, input specific project details into the system. Each project in the system, having unique characteristics defined by the buyer and constrained by the system, will only associate with appropriately defined nodes. Association must occur simultaneously at multiple levels.

The present invention further provides for application levels:

Level 1→Sector→SubSector→Industry→Project Type
The system has a classification structure that parallels the North American Industry Classification System (NAICS) but is modified to improve functionality
Each project created is defined to the “Project Type” level
Each node is defined to the “Industry” level and single or multiple “Project Type” categories

Level 2—State
Each project created is defined according to the State in which the project is going to be executed
Each node is defined by the States in which the vendor can legally offer that product or service

Level 3—Date
Each project created is defined according to when it will begin and the anticipated duration
Nodes may or may not be defined according to available dates, depending on the characteristics of the product/service delivery. Any node without an availability date is assumed to be available at all times

Level 4—Required products and services
Each project, based on the previous levels of definition, will be assigned a required set of products and services. This set of requirements is provided by the system based on inventor's expert knowledge of project types in certain locations. The system could be modified to learn from user customization of the required set and other Levels to better determine requirements for future projects.
   Each node is defined, upon creation by the vendor, as a product or service from a list of options provided by the system based on inventor's expert knowledge of project types in certain locations and industry-specific nomenclature. The system could be modified to learn from user customization of nomenclature and other Levels to better determine proper association with future projects.

Level 5—Location
Each project created is defined by its geographical location. This will be geographic Latitude and Longitude either entered directly or determined indirectly from electronic map selection (point and click) or address entry.
Each node is defined by its geographical location. This will be geographic Latitude and Longitude either entered directly or determined indirectly from electronic map selection (point and click) or address entry. Geographic location is the point from which the vendor delivers products and services and is generally static for a particular node. Certain nodes will have a dynamic location whereby the vendor can regularly update that location as the node moves from project to project, ensuring continued relevance for newly created projects.

Non-associating characteristics: While the project and node characteristics required for association have been defined previously, there are other characteristics that are not required for association but are necessary for users. Particularly, the project is characterized by the buyer's profile details. The buyer's profile includes employer, job title and office location. Each node is characterized by the vendor's profile details, such as company name, headquarters location, operating description and active industries. The node is additionally characterized by the personnel responsible for delivery, such as salespersons, operational personnel, and dispatchers, and their contact information.

Nodes are component to a database. Upon creation of a project and assignment of the required products and services, the buyer can modify the assigned list, adding or removing certain products or services as they see fit. The system will then query the node database within a certain geographic radius (according to Level 5 definition) to find all nodes that satisfy the required association at the first four Levels. The system will then determine the driving distance for each of the qualifying nodes and provide a truncated list of node options for each of the required products and services. Those node options will be sorted according to driving distance.

The buyer can select the desired node for each of the required products and services and hence create a vendor list for the project. Upon selection of the desired node for each of the required products and services a project-node object is created and added to the database.

The system further provides a method of contact with responsible parties characteristic to each of the nodes found to have the required associations described previously. Upon generation of the proximity-sorted node options for each of the products and services required to execute a project, the buyer can provide a general project summary and/or specific details for each of the required products and services. The system will provide notice to the appropriate contact for each of the nodes and a “request for quote” or “request for proposal”, commercial or technical, can be provided by the buyer to the node contact. Each node contact can subsequently reply to the buyer with a commercial or technical proposal or a “request for clarification”. This exchange can continue until all parties are satisfied and based on this information the buyer can select the desired node for each of the required products and services and hence create a vendor list for the project. Upon selection of the desired node for each of the required products and services a project-node object is created and added to the database.

The system further provides a means of feedback to rate the quality of products or services associated with each node. Upon completion of the activity prescribed for a specific project-node object, the buyer is prompted by the system to provide feedback on the quality of the services. Service quality is rated on a uniform scale for each of a series of parameters including, but not limited to, timeliness, expertise, results v objectives, and safety. That information is made available to the appropriate contact for each node and a window of time is available for the vendor to resolve differences prior to that feedback being permanently associated with that node.

The system further provides a means of maintaining a record of quality results associated with each node. The system database will be updated according to buyer feedback to provide quality statistics on each node. During the query process that information will be made available to the buyer. In this manner the buyer will be able to evaluate the viability of a particular node based on the feedback of other buyers within and without that buyer's organization.

The system further provides a means of secondary association with nodes deemed relevant according to the previously defined required associations as well as service quality metrics defined by the buyer. The secondary association requirements defined by the buyer, either generally at the project level or specifically at the product/service level, are used as a filter to refine the query results described previously.

The system further provides a means of generating service quality reports. Users, buyers and vendors, are able to evaluate the service quality results of nodes, at any level of node characteristic, to determine the quality of a particular node, vendor, vendor product or service, or vendor location. Those results can be compared with other nodes, vendors, vendor products or services, or vendor locations. In addition buyers can compare the service quality provided on their projects with service quality provided on other buyer projects by the same node, vendor, vendor product or service line, or vendor location.

The system further provides a means of tertiary association with nodes deemed relevant according to the previously defined required associations as well as buyer organization requirements defined by the buyer. The tertiary association requirements defined by the buyer, either generally at the project level or specifically at the product/service level, are used as a filter to refine the query results described previously. Tertiary association requirements may include, but are not limited to, “approved vendors” defined by the buyer's organization, technical certifications, safety certifications, registration with third party groups, or recognition by certain government or industry organizations.

The system further provides a means of tracking project progress by vendors and buyers. With the creation of unique project-node objects, those objects are serialized. Serialization provides for image-based coding, such as bar codes, QR codes, or some variation thereof, whereby field tickets and invoices can be recognized via scanning devices. Users can designate certain milestones via computer or mobile device, manually selecting the appropriate object, or use a scanning device to automatically call for the appropriate object within the system database. The appropriate user and object milestone options may be expanded to meet the needs of the user, but are anticipated to include:

Buyer—Anticipated time of service delivery

Buyer—Call for service delivery

Vendor—Departure from the delivery point or assignment to project

Buyer—Arrival of products and services

Buyer—Completion of the prescribed delivery

Vendor—Departure from project site

Vendor—Arrival to the delivery point or release from project

The system further provides a means of more rapidly initiating billing processes. At the completion of the prescribed delivery, buyers currently approve field tickets by signature to facilitate invoicing by the vendor. The current methodology requires receipt of the signed field ticket by vendor accounts-receivable, so physical arrival to the delivery point is often required. Based on recognition of the milestones mentioned previously, the system will automatically generate an approved field ticket, if so desired by the buyer, from which an invoice can be generated and delivered to the buyer organization. This can be achieved prior to actual receipt of any physical document by the vendor organization.

The present invention is broken down into functional areas, or areas of focus, each related but allowing access to different information and functions. The areas of focus for the buyer and vendor interface are consistent but altered according to user perspective. The areas of focus may be expanded to meet the needs of the user, but are anticipated to include:

| | |
|---|---|
| Vendor | Buyer |

| | |
|---|---|
| Comm Center | Comm Center |
| My Customers | My Vendors |
| My Projects | My Projects |
| My Products | My Resources |
| My Team | My Team |

In general, each area of focus requires substantial processing. Therefore, functionality within an area of focus has been broken down into what are termed subject areas. A subject area is simply a subset of related information and/or processes within an area of focus. For example, within the Vendor Comm Center there are numerous subject areas such as requests for information, requests for quote, requests for clarification, award notifications, and timing changes. Each subject area is identified by sidebar navigators and can be accessed using these navigators or other links within the area of focus. The subject areas may be expanded to meet the needs of the user, but are anticipated to include:

| Vendor | | Buyer | |
|---|---|---|---|
| | Comm Center In | | Comm Center In |

| | |
|---|---|
| Request: Information | Response: Information |
| Request: Quote | Response: Quote |
| Request: Clarification | Response: Clarification |
| Award Notification | Award Recognition |
| Timing Change | Availability Change |

| | |
|---|---|
| Comm Center Out | Comm Center Out |

| | |
|---|---|
| Response: Information | Request: Information |
| Response: Quote | Request: Quote |
| Response: Clarification | Request: Clarification |
| Award Recognition | Award Notification |
| Availability Change | Timing Change |

| | |
|---|---|
| My Customers | My Vendors |

| | |
|---|---|
| Organization | Organization |
| Location: Office | Location: Office |
| Location: Operations | Location: Operations |
| Contact: Engineer | Contact: Operations |
| Contact: Purchasing | Contact: Sales |
| Contact: Admin | Contact: Field Lead |
| Contact: Field Lead | Contact: Admin |

| | |
|---|---|
| My Projects | My Projects |

| | |
|---|---|
| Date: Start | Date: Start |
| Customer | Vendor |
| — | Incomplete |
| Award Pending | Award Pending |
| Ready | Ready |
| Operating | Operating |
| Completed | Completed |
| Closed | Closed |

| | |
|---|---|
| My Products | My Resources |

| | |
|---|---|
| Organization | Industry |
| Region | Project Type |
| Product | Products |
| Project Type | Region |
| Industry | New White Papers |
| Date: Availability | Performance |
| — | Commentary |

| | |
|---|---|
| My Team | My Team |

| | |
|---|---|
| Operations Rep | Operations Manager |
| Sales Rep | Engineers |
| Field Leaders | Field Leaders |
| Admin | Admin |
| Quality Assurance | Purchasing |
| Accounting | Accounting |
| Legal | Legal |

In order to solve the difficulties presented in attempting to obtain the features of the present invention, a system and software has been developed which seamlessly combines sophisticated identification, location, selectable filters or criteria, and project to services/products matching techniques and analysis. The present invention is anticipated to be a web-based application that is accessed via an Internet browser and is designed for easy use. Basic navigational tools such as point and click, scroll bars, buttons and tabs are used throughout the application.

While the present invention is not intended to be exclusively controlled by computer programs or algorithms on the Internet, it is intended that the present invention can be implemented and controlled by computer programs or algorithms over the Internet, or other computer network. Therefore, the present invention contemplates a series of computer algorithms and method by which the present invention is implemented and controlled. Thus, in some of the descriptions herein, the present invention is presented partly in terms of process steps and operations of data bits within a computer memory. An algorithm is here, and generally, conceived to be a self-consistent sequence of steps leading to a desired result. These steps are those requiring physical manipulations of physical quantities. In the present invention, the operations referred to may be automated, machine operations done by a computer or similar device performed in conjunction with a human operator.

The present invention relates to the methods for operating such devices, and processing electrical, magnetic, optic, or other physical signals to generate other desired physical signals. It further relates to a computer program and the control logic contained therein. The present invention also relates to apparatus for performing these operations. The apparatus may be specially constructed for the required purposes or it may comprise a general purpose computer selectively controlled or reconfigured by a computer program stored in the memory of the computer. Further, because the present invention is intended to include a network of participants, with no geographic limitations, it is contemplated that to better implement the system of the current invention, at least part of such implementation will take place on the Internet, or other computer network. The method presented herein is not inherently related to any particular computer or other apparatus. Similarly, no particular computer programming language is required. The required structure, although not machine specific, will be apparent from the description herein. Additionally, even though a specific device or software application may, or may not, be mentioned in conjunction with a step, or algorithm, or action, it is intended that any appropriate device or software application necessary or capable of implementing that step, or algorithm, or action is anticipated herein. For example, if a step calls for the input of data, it is contemplated that any appropriate devices such as, but not limited to, various input devices, output devices, data storage devices, data transfers devices, could be used and are anticipated herein.

### BRIEF DESCRIPTION OF THE DRAWINGS

FIG. 1 is a schematic illustrating the present invention.

FIG. 2 is a flowchart illustrating the system database flow of the present invention.

FIG. 3 is a flowchart illustrating initial user interaction with the present invention.

FIG. 4 is a flowchart illustrating buyer interaction with the present invention.

FIG. 5 is a flowchart illustrating buyer interaction or buyer project query routine of the present invention.

FIG. 6A is a first portion of a flowchart illustrating how the present invention associates characteristics for the buyer.

FIG. 6B is a first portion of a flowchart illustrating how the present invention associates characteristics for the buyer.

FIG. 7 is a flowchart illustrating how buyer feedback is incorporated into the present invention.

FIG. 8 is a flowchart illustrating how the present invention captures quality details of the node level.

FIG. 9 is a flowchart illustrating how vendor accounts are initiated within the present invention.

FIG. 10 is a schematic illustrating how the present invention creates a shopping list for the user.

FIG. 11 is a schematic illustrating how the present invention illustrating the buyer interface workflow of the present invention.

FIG. 12 is a schematic illustrating the vendor node structure of the present invention.

### DETAILED DESCRIPTION OF THE PREFERRED EMBODIMENT

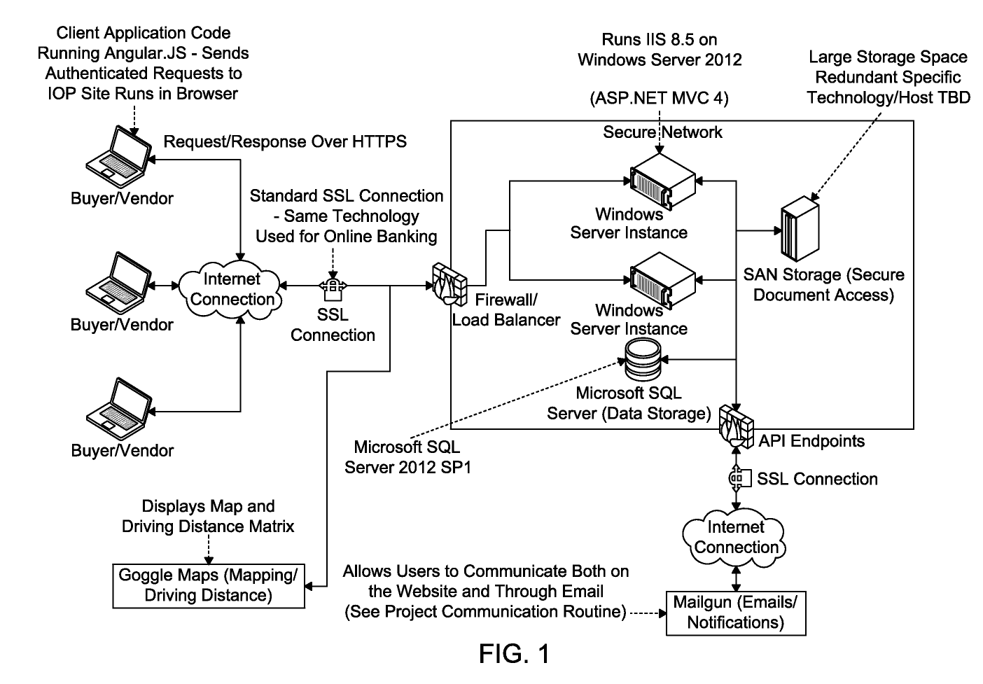

Referring to the figures, FIG. 1 is a schematic illustrating the present invention. The present invention is run through a secure network is comprised of any number of servers. The multiple servers allow for redundancy within the network. Connected to the network hardware dedicated to storage of secured documents. It is anticipated that this storage will include an excess of memory in order to allow for redundant storage of data. In SQL Server for data storage may also be incorporated into the network. For access to the network, users' electronic communication must pass through a firewall/load balancer. The connection to the network for the buyers and vendors may be across the Internet or through any other remote access network. It is anticipated that the connection will be a secured one such as a standard SSL connection.

Buyers and vendors will access the network remotely. The communication from buyers and vendors sans authenticated requests to the system from a standard Internet browser.

As a part of the system, a navigational application will be accessed in order to help establish geographic references between buyers and vendors. Thus, mapping and driving distance for shipping can be estimated, and a map and driving distance matrix can be displayed.

It is also anticipated that the current invention will allow for communication between the buyers and vendors. Thus, the system will also be in communication through an API endpoint and over a secure connection on the Internet to an email or other communication application. This allows users to communicate both on the website and through direct communications such as email, texting, voice texting, or other communication methods. This is referred to as the project communication routine.

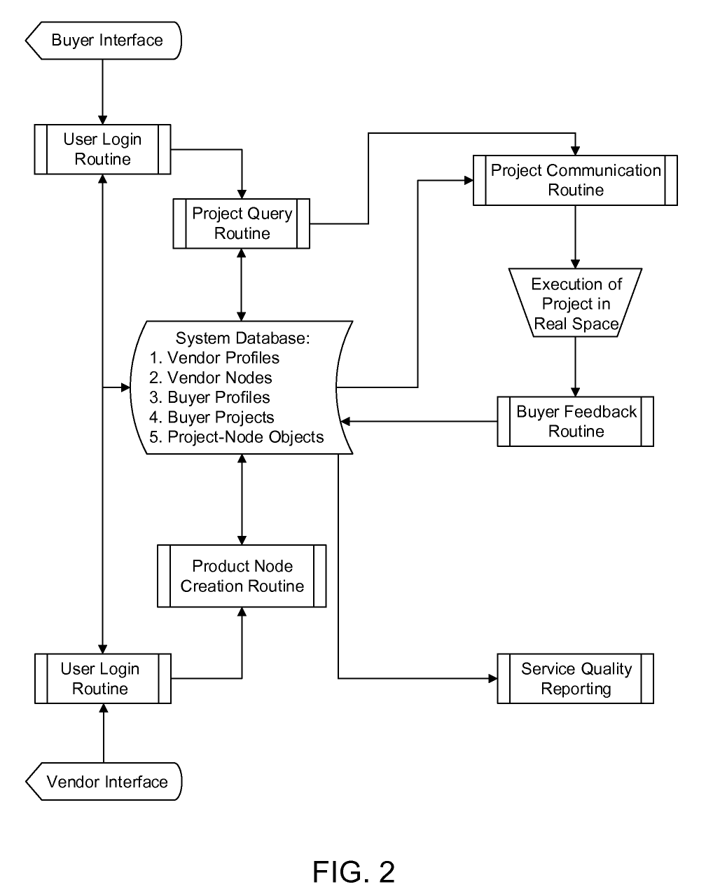

FIG. 2 is a flowchart illustrating the system database flow of the present invention. Through a buyer interface, or vendor interface, a user login routine is run. From the buyer interface side, a project query routine runs, while from the vendor interface side a product node creation routine runs. Other routines include a project location routine, which leads to the execution of the project in real space and provides for a buyer feedback routine. From these routines the system database receives vendor profiles, vendor notes, wire profiles, buyer projects, and project-node objects. In the end, the quality of the service provided by the vendor can be reported.

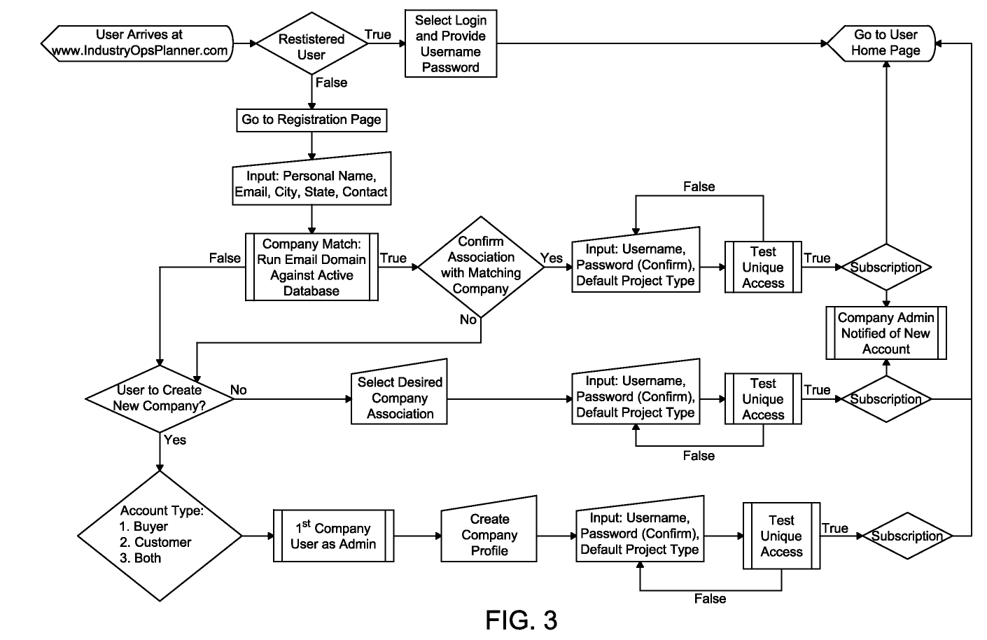

FIG. 3 is a flowchart illustrating initial user interaction with the present invention. The user, either a buyer or vendor, uses an Internet browser to access a portal website of the control process. If the user is registered, then the login information will be requested. Upon the including a username and password, the user will be sent to a user homepage. From the homepage various subscriptions may be accessed.

If the user is not registered, then the user will be redirected to a registration page. At that point the user can input personal information such as name, email, city, state, and contact. In order to reduce the possibility of creating multiple accounts for the same user, a company match is run by checking the new users email domain against others in the active database. If a match is found, then the program will attempt to confirm the new users Association with the matching company. If there is a match, then the user will be asked to input the username and password information of the existing account. It is tested for unique access and if it passes than the user is moved onto a subscription. If the access does not pass then the user is returned to the login page. If there is no match between the new user and the existing user, then the process asked if the user would like to create a new company. If the user chooses to create a new company account then an account is created. The account type may be either as a vendor (or buyer), customer, or both. If the user does not want to create a new company account then the user may select a desired company Association. After either creating a new account for entering the correct login information and associating with an existing account then the user will have access to the control process.

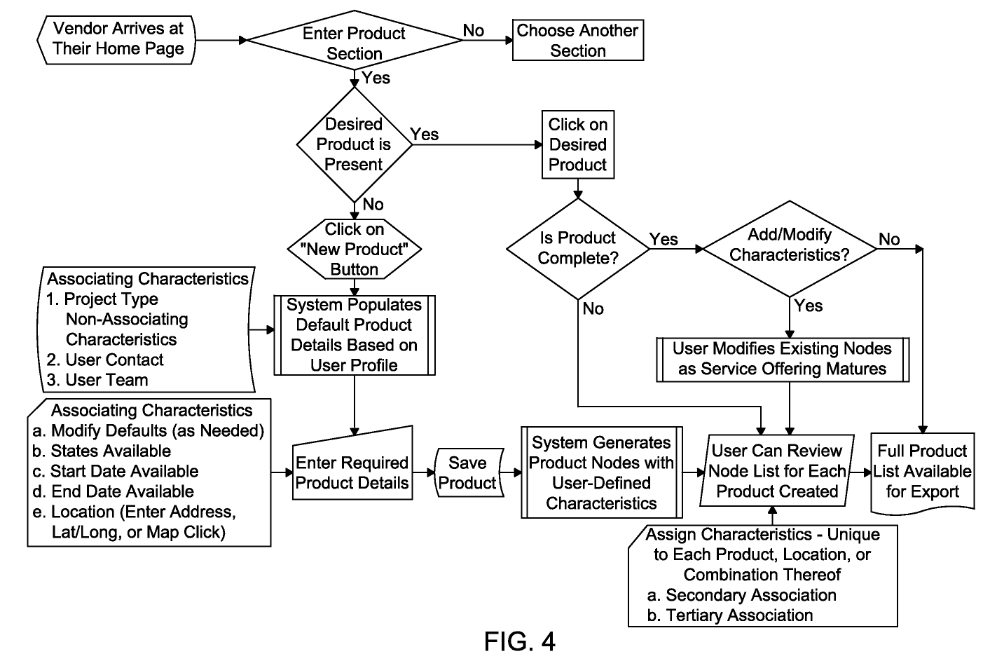

FIG. 4 is a flowchart illustrating buyer interaction or buyer project query routine of the present invention. Once the login is complete and the buyer is at their home page, they enter a project section. If their desired project is present and they click on it and are queried whether the project is complete. If so they are asked to add or modify items. In this way, the user generates a custom “shopping list” of required products and services. The user can review the “shopping list” and customize it.

If a desire project is not present them the user may create a new project. The system will populate default project details based upon the user's profile by associating characteristics such as project type, user contact, and user team. Project details are entered and characteristics are associated with defaults or by modifying the defaults as necessary. Some of the details include the state in which the project is located, start date of the project, duration of the project, position (by latitude and longitude or map click) of the project location. After the required project details are entered, the project is saved in the control process generates an initial shopping list of required products and services based upon projected characteristics and previous similar projects as learned by the system. As described above, the user can then review the shopping list and customize it as desired.

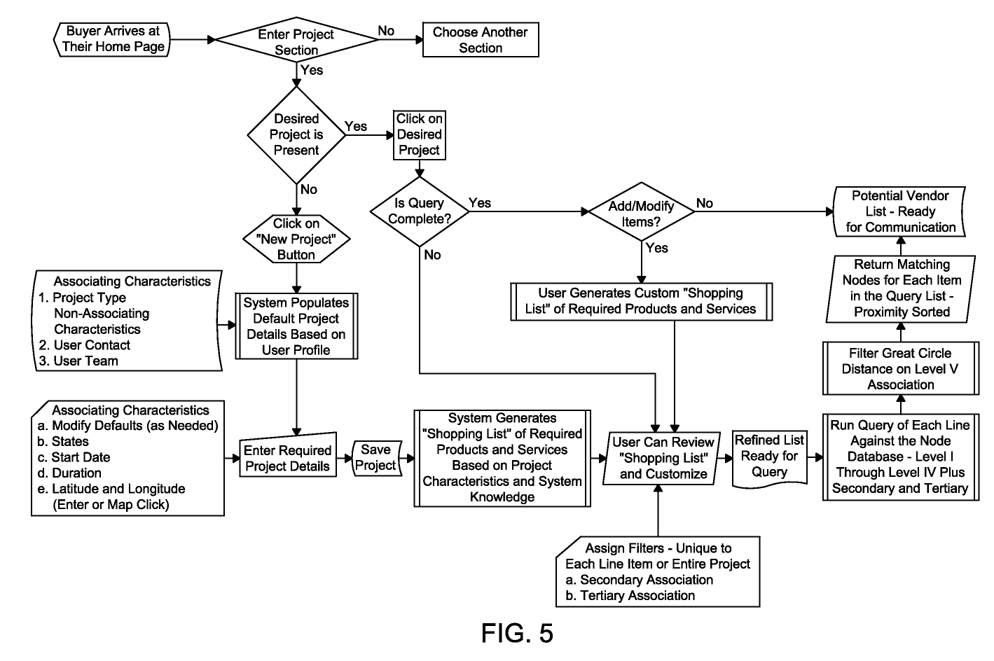

FIG. 5 is a flowchart illustrating buyer interaction or buyer project query routine of the present invention, and is an extension of FIG. 4. After the user generates a custom “shopping list” of required products and services. The user can review the “shopping list” and customize it. The refined list is ready for a query. A query is run for each line of the node database, level I through level IV, plus secondary and tertiary nodes. After the queries are run, the level V association is filtered for distance and in the and a query list with matching notes for each item in the list is returned with the proximity sorted. Thus, once the items are modified and a final shopping list generated, or if the user does not want to add or modify items, then they are provided a potential vendor list ready for communication.

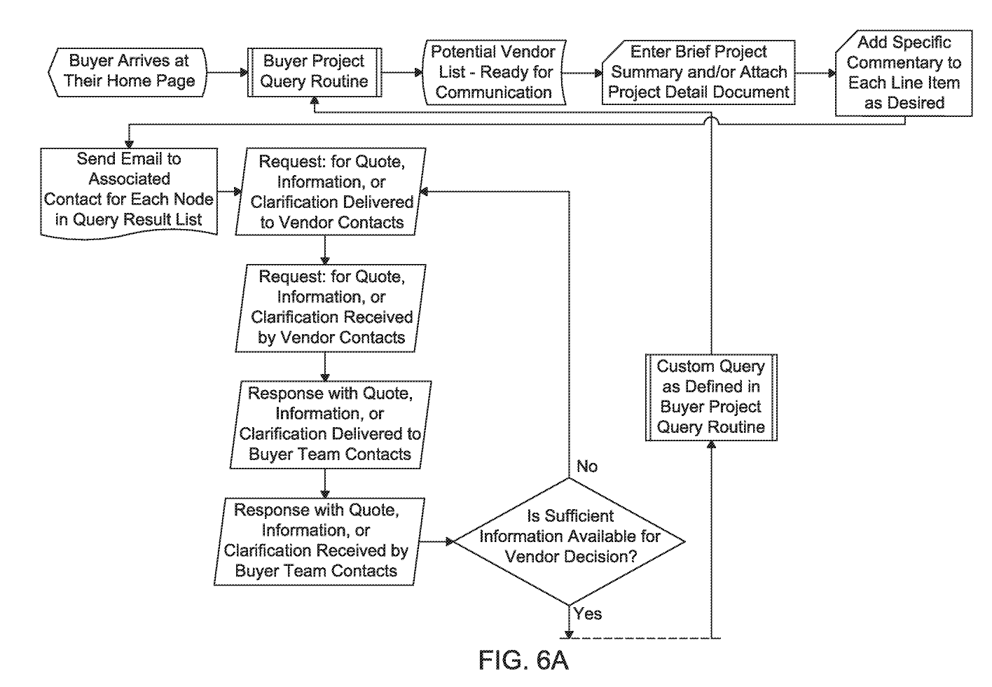

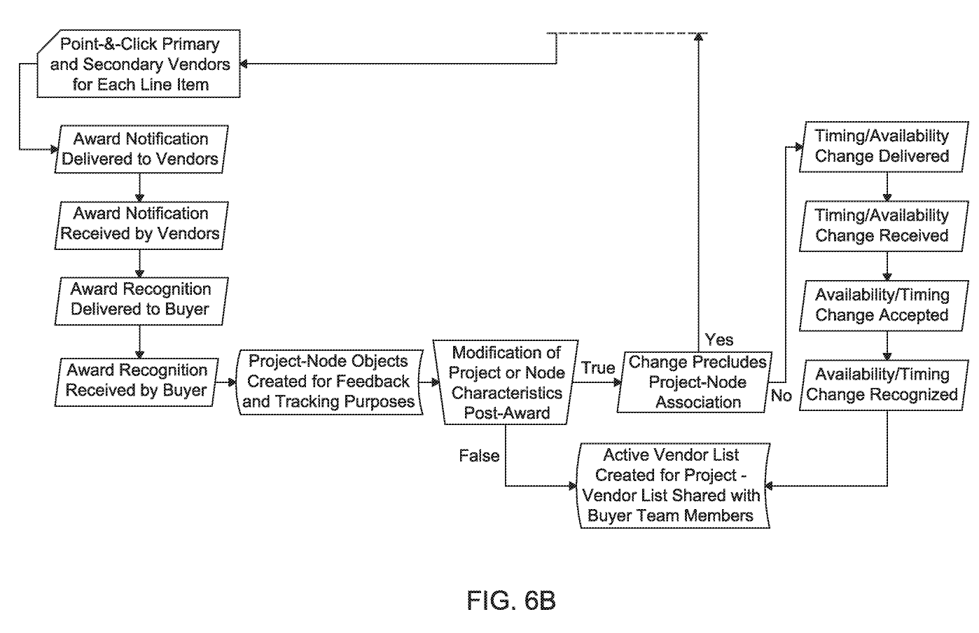

FIGS. 6A and 6B are a flowchart illustrating how the present invention selects and confirms vendor information. After the buyer project query routine a potential vendor list is prepared and ready for communications between buyer and vendor. The buyer enters a brief project summary and may attach a detailed project document in which specific commentary may be added as desired. The communication is sent for each node in the query result list. The communication includes a request for a quote, information, or clarification delivered to vendor contacts or by vendor contacts. If sufficient information is available the vendor will make a decision to provide goods or services to the buyer. The control system may identify both primary and secondary vendors for each line item in the shopping list. An award notification of the items is delivered to the selected vendors, as well as to the buyer. A project node object is created for feedback and for tracking purposes. The project node characteristics may be modified. The feedback and tracking project node objects may modify the active vendor list that is shared with buyers associated with the control process.

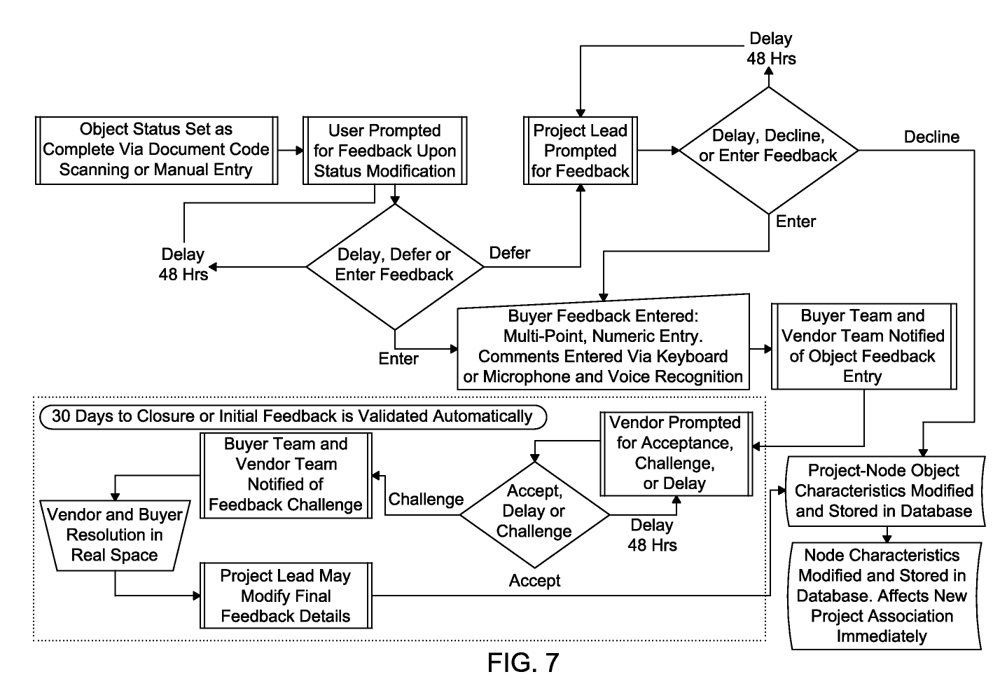

FIG. 7 is a flowchart illustrating how buyer feedback is incorporated into the present invention. Buyer feedback is entered the keyboard or microphone with voice-recognition. The feedback is used by the control process to help select or modify the vendors that may be selected by the control process. It also allows issues between the vendors and buyers to be resolved.

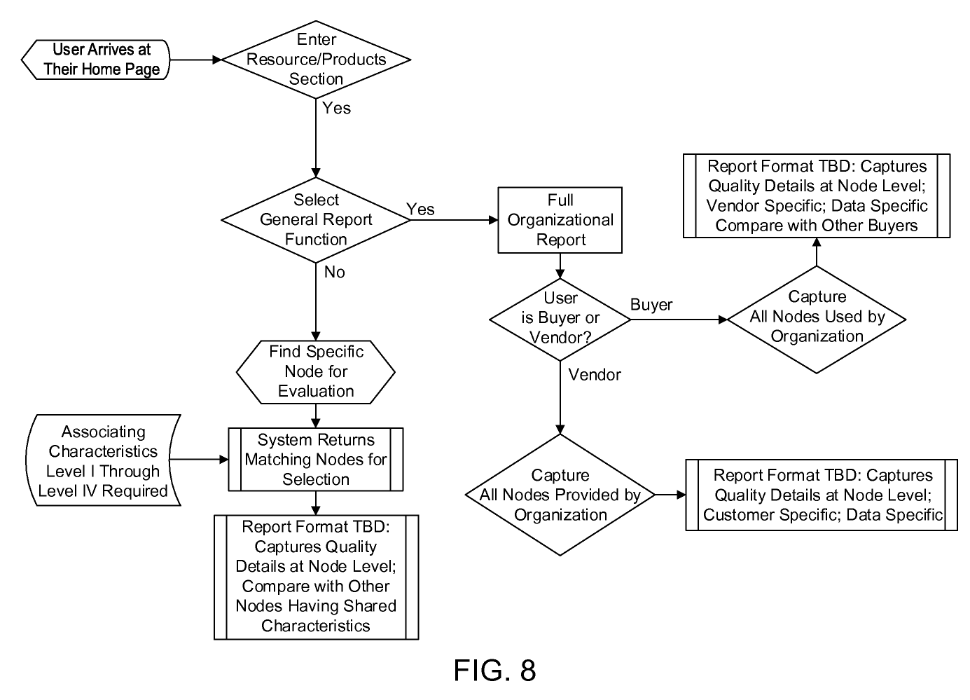

FIG. 8 is a flowchart illustrating how the present invention captures quality details of the node level. The control process may provide for reporting functions. The full organizational report requires a determination of whether the user is a firefight and. If the user is a buyer, the process will capture all nodes used by the organization and prepare a report that captures quality details at the node level, which is vendor specific and date specific, and will compare them with other buyers.

If the user is a vendor, then all the notes are captured and a report is prepared that captures quality details of the node level with customer and date specific information.

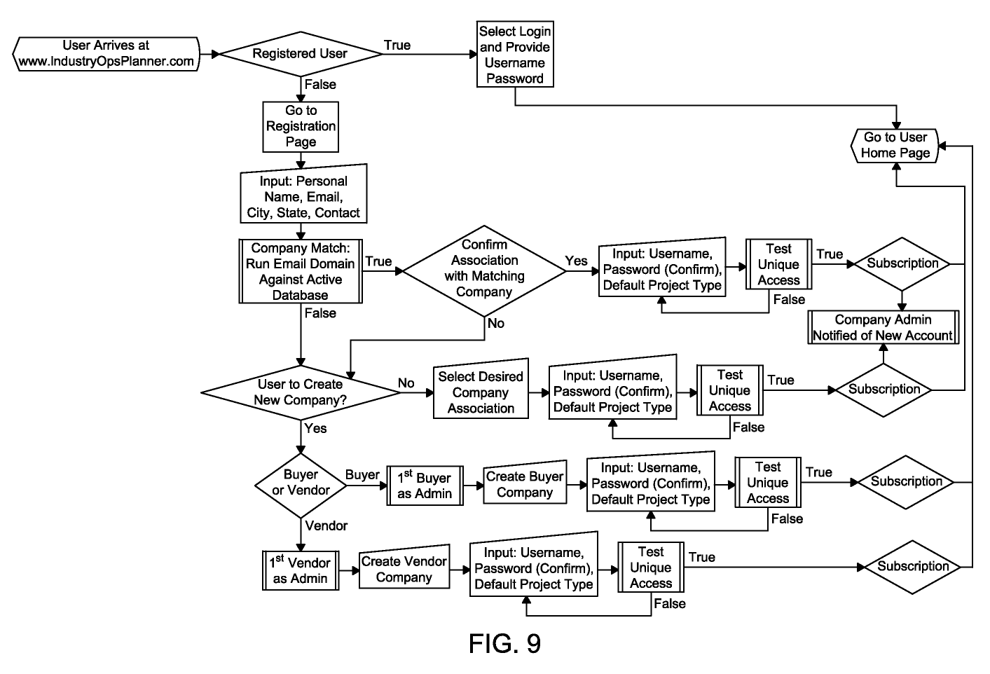

FIG. 9 is a flowchart illustrating how vendor accounts are initiated within the present invention. The control system opens and modifies and confirms vendor and buyer accounts in a manner similar to those for buyers as illustrated in FIG. 3.

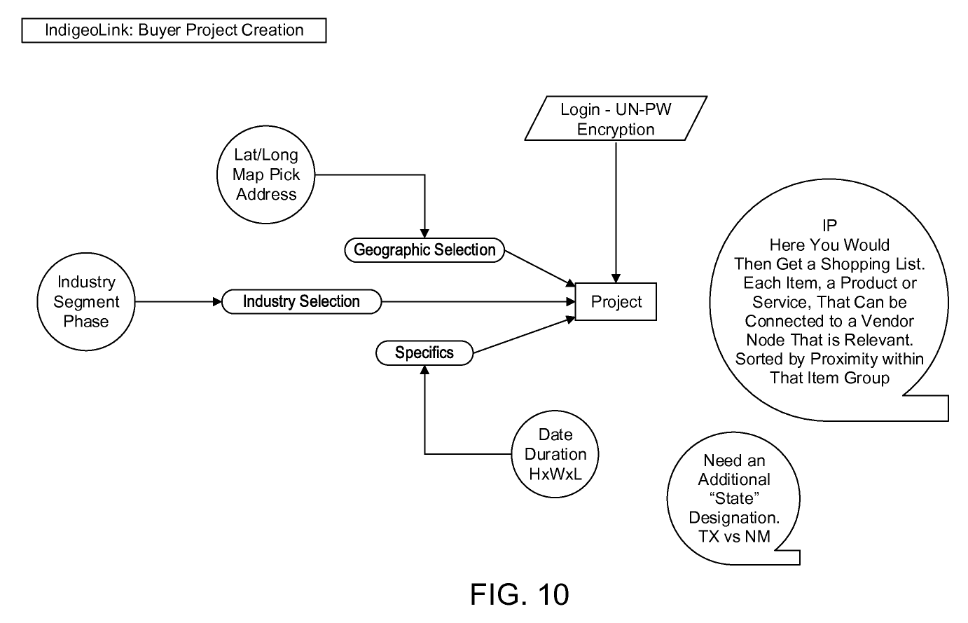

FIG. 10 is a schematic illustrating how the present invention creates a shopping list for the user and buyer project creation. The selection includes geographic selections, industry selections and specifics of the project such as date and duration. By completing a project generates a project shopping list. Each item, whether it be a good or service, they can be connected to a vendor node may be included. In order to decrease transportation and shipping costs, the vendor notes may be sorted by proximity to the project site for a particular good or service.

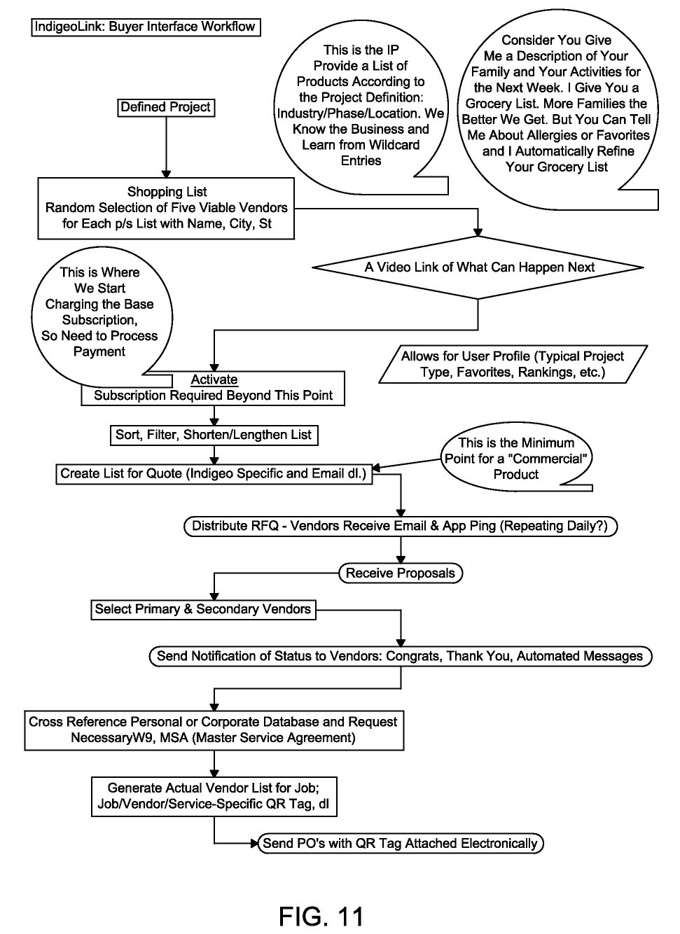

FIG. 11 is a schematic illustrating how the present invention illustrating the buyer interface workflow of the present invention. Once a project is defined a shopping list is created. Vendors are selected based upon their being able to provide the product or service and their proximity to the jobsite. Multiple potential vendors may be provided to the buyer. A video link is created and provided to the buyer which describes the process. In order to continue the buyer must activate a subscription. Once activated the project list may be edited which results in a list available for quotes. This is the minimum point for a quote commercial” product. The list allows for distribution of a request for a request for quote (“RFQ”). The RFQ is distributed to vendors who receive medications and reminders regarding the RFQ. Vendors send proposals back to the buyer who selects a primary and secondary vendor. Once selected, chosen vendors are notified of their selection. Various required documents and agreements may be provided to the buyer and vendor. After selection and actual vendor list for the job is generated and purchase orders are sent to the vendors.

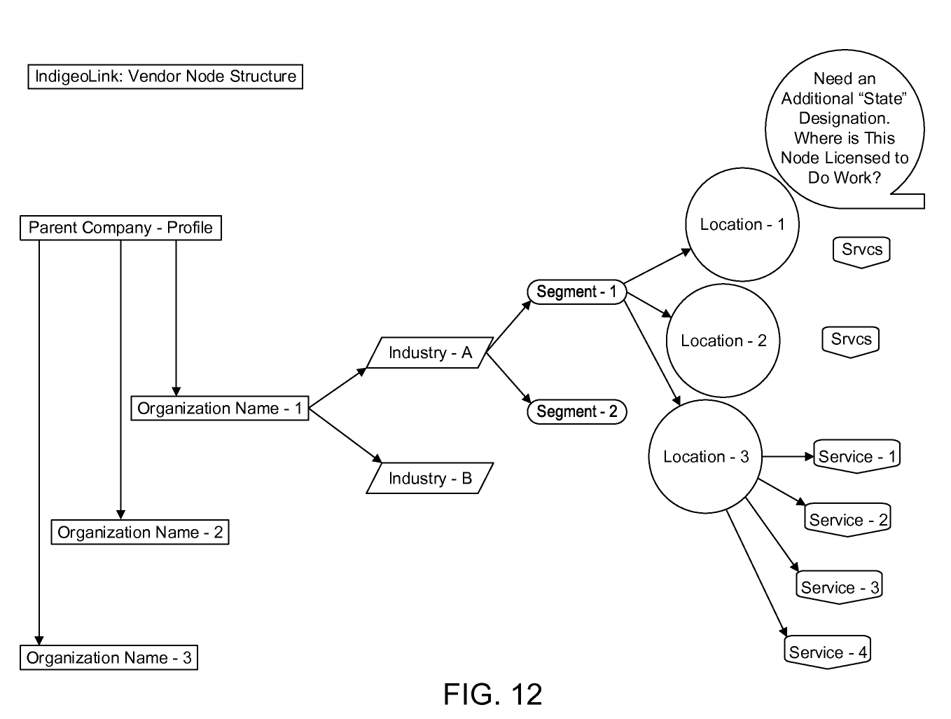

FIG. 12 is a schematic illustrating the vendor node structure of the present invention. The nodes include a hierarchy of profile, names, industry, segments, locations, and finally goods and services. Additionally, a State designation may be included in order to confirm in what areas the vendor is licensed to work.

Although the invention has been described with reference to specific embodiments, this description is not meant to be construed in a limited sense. Various modifications of the disclosed embodiments, as well as alternative embodiments of the inventions will become apparent to persons skilled in the art upon the reference to the description of the invention. It is, therefore, contemplated that the appended claims will cover such modifications that fall within the scope of the invention.

I claim:

1. A method in a computer system for generating purchase orders to selected vendors, the method comprising:
creating an account for a buyer;
creating accounts for multiple vendors;
obtaining project information from said buyer;
obtaining project location information from said buyer generating a list of appropriate vendors for said project from said multiple vendors;
communicating a request for quote to said appropriate vendors;
selecting a single vendor for a product;
generating a purchase order and forwarding said purchase order to said single vendor.
